(19) United States
(12) Patent Application Publication
(10) Pub. No.: US 2022/0118886 A1
(43) Pub. Date: Apr. 21, 2022

(54) METHOD FOR CONTROLLING A VEHICLE SEAT VALVE

(71) Applicant: Faurecia Autositze GmbH, Stadthagen (DE)

(72) Inventors: Gerd Wielgosz, Greding (DE); Detlef Ricken, Langenlonsheim (DE); Sandeep Todkar, Pune (IN)

(73) Assignee: Faurecia Autositze GmbH, Stadthagen (DE)

(21) Appl. No.: 17/487,416

(22) Filed: Sep. 28, 2021

(30) Foreign Application Priority Data
Oct. 20, 2020 (DE) 102020127539.0

(51) Int. Cl. B60N 2/02; F16K 31/06

(52) U.S. Cl. CPC B60N 2/0224; F16K 31/0675

(57) ABSTRACT

A method for controlling a vehicle seat valve, the piston thereof is actively displaced from a closed position into an open position or vice versa by an electrical voltage being applied to an electromagnetic drive means. The power of the drive means is regulated via an effective voltage which can be changed by means of pulse width modulation of an impulse voltage that has a constant frequency. In order to displace the piston from its closed position toward its open position, a duty cycle of the pulse width modulation is firstly increased from a rest duty cycle to a starting duty cycle of less than 100%, and the duty cycle is only raised to a final duty cycle when the piston has reached the open position and/or if a blockage impeding the displacement of the piston before it reaches its open position is identified.

### STATEMENT OF RELATED APPLICATIONS

This application claims the benefit of and priority on German Patent Application No. 10 2020 127 539.0 having a filing date of 20 Oct. 2020.

### BACKGROUND OF THE INVENTION

### Technical Field

The invention relates to a method for controlling a vehicle seat valve, the piston of which is actively displaced from a closed position into an open position or vice versa by an electrical voltage being applied to an in particular electromagnetic drive means. The invention also relates to a controller for at least one vehicle seat valve, for carrying out this method, and a vehicle seat comprising at least one vehicle seat valve and a controller of this kind.

### Prior Art

Seats which are to be arranged in particular in vehicles sometimes have at least one functional apparatus which can be operated via a fluid pressure. These functions range, for example, from ergonomically adapting the seat to a massage function. In addition to electrical actuators, hydraulically or pneumatically operated expansion bodies are also used for this purpose. An expansion body of this kind, also referred to as a “balloon,” comprises at least one cavity which is as fluid-tight as possible, with mechanical work resulting from a volume change of this cavity that is based on filling and emptying.

The compressor used to build up the required fluid pressure can be placed inside or outside the vehicle seat, for example, such that the expansion body is operated extremely quietly. It is usually supplied by tubes fluidically connected to the compressor. Each tube is associated with at least one vehicle seat valve, via which the targeted filling and emptying of the particular expansion body can be controlled, for example. As the number of expansion bodies increases, the amount of vehicle seat valves required for control increases accordingly. To this end, vehicle seat valves of this kind can be combined to create a unit in the form of a valve block. With regard to the design of vehicle seat valves of this kind, those comprising a linearly displaceable piston are typically used.

DE 10 2013 225 690 A2 discloses a vehicle seat in which the backrest, which is hingedly arranged on a seat part, has a plurality of pneumatic expansion bodies. These can be filled with compressed air by a compressor, with the introduction and discharging of the compressed air being controlled in each case via a vehicle seat valve fluidically arranged between the compressor and an expansion body. These vehicle seat valves are designed as solenoid valves, have a corresponding electromagnetic drive means, and can be controlled via a controller connected thereto.

An electrical voltage is usually applied to the drive means of the vehicle seat valves so that the piston thereof that blocks or allows the fluid flow can be linearly displaced from a closed position into an open position and/or vice versa. In practice, this can occasionally produce clearly perceptible switching noises which result in particular from the piston accelerated by its drive means hitting against its structural movement boundary.

### BRIEF SUMMARY OF THE INVENTION

Against this background, the problem addressed by the invention is that of developing a method for controlling a generic vehicle seat valve such that the switching noises thereof are reduced to a minimum at least in normal operation.

This problem is solved according to the invention by a method for controlling a vehicle seat valve, the piston of which is actively displaced from a closed position into an open position or vice versa by an electrical voltage being applied to an in particular electromagnetic drive means, characterized in that the power of the drive means is regulated via an effective voltage which can be changed by means of pulse width modulation of an impulse voltage that has a constant frequency, a duty cycle (D) of the pulse width modulation firstly being increased from a rest duty cycle (D1), in particular 0%, to a starting duty cycle (D) of less than 100%, in particular of less than 50%, in order to displace the piston from its closed position toward its open position, and the duty cycle only being raised to a final duty cycle (D4), in particular to 100%, when the piston has reached the open position and/or if a blockage impeding the displacement of the piston before it reaches its open position is identified. Advantageous embodiments can be found in the dependent claims. This problem is also solved by a controller for carrying out the method according to the invention, and by a vehicle seat having the controller for carrying out the method according to the invention.

With reference to the method according to the invention, it is proposed to regulate the power of the drive means via an effective voltage which can be changed by means of pulse width modulation (PWM). Specifically, an impulse voltage that has a constant frequency forms the starting point, with the effective voltage that is ultimately applied to the drive means of the vehicle seat valve merely being changed to the desired value by manipulating the duty cycle of the pulse width modulation of the impulse voltage.

In other words, the impulse voltage present as a direct voltage is periodically switched on and off more or less within the scope of its frequency, with the associated period duration of each on-and-off iteration being obtained as a quotient of an individual second divided by the predefined frequency in Hertz (Hz) (period duration=1/frequency [Hz]). The duty cycle ultimately means the ratio of the pulse duration (on) to the period duration, with a duty cycle of 50% changing the period duration of the impulse voltage into an effective voltage having an equally long pulse duration (on) and pause (off). Starting from a purely exemplary period duration of 3.0 milliseconds (ms), the pulse duration and pause would each be 1.5 ms. Still by way of example, an impulse voltage of 12 volts (V) could be changed to 6 V by a pulse width modulation having a duty cycle of 50%. A duty cycle of 75%, for example, would change the impulse voltage from 12 V to 9V, while a duty cycle of 25%, for example, would change the impulse voltage from 12V to 3V. In so doing, the power of the drive means can be regulated solely by means of a pulse width modulation of the impulse voltage and the resulting effective voltage ultimately applied to the drive means being even down to 0 V, by a duty cycle of 0% being set.

In order to displace the piston from its closed position toward its open position, the duty cycle of the pulse width modulation is initially increased, starting from a rest duty cycle, to a starting duty cycle which is less than 100%, preferably less than 50%. In so doing, the drive means of the vehicle seat valve is initially supplied with an effective voltage below the impulse voltage, so that the power thereof is accordingly throttled. The rest duty cycle is only raised to a final duty cycle, which can preferably be 100%, once the piston has reached the open position. The drive means thus only deploys its full power once the piston has reached the open position. Alternatively or additionally thereto, the rest duty cycle can be raised to the final duty cycle if a blockage impeding the displacement of the piston is identified before the piston reaches its open position.

The resulting advantages include significantly quieter operation of the vehicle seat valve. This is substantially due to the power of the drive means thereof that is reduced at the beginning of the displacement of the piston toward its open position, so that the drive means does not hit against the structural movement boundary thereof at maximum force.

In this case, the duty cycle can only be raised to the final duty cycle, for example, after a specified time period from the beginning of the raising of the rest duty cycle, at the end of which time period it can usually be expected that the piston has reached its open position. At this point in time, the piston is already abutting against a region of its movement boundary, and therefore the raise to the final duty cycle simply causes a contact pressure of the piston against the movement boundary region to increase to the same extent, thereby producing no mechanical noise emissions whatsoever. At the same time, it is ensured that a movement blockage of the piston, which is caused, for example, by temperature and/or other influences and is in itself unnoticed and for which the starting duty cycle could not generate a sufficiently high breakaway force of the drive means, is in any case overcome. Although corresponding noise emissions would be produced from the piston that is displaced at a correspondingly high power or acceleration when it hits against its structural movement boundary, the function of the vehicle seat valve would also be ensured even outside normal operation without blockages of this kind.

If at least one means for identifying a movement blockage of the piston is provided, the starting duty cycle can be raised to or at least toward the final duty cycle in the moment of this movement blockage being identified. In fact, the means for identifying a movement blockage can be used as the starting duty cycle is being raised in order to monitor the success of this measure, so that, for example, when the blockage is identified as being unblocked, the action of the starting duty cycle being raised further toward the final duty cycle can be stopped in order to minimize the noise omissions of the piston that is already being displaced at an increased power and thus hitting against its movement boundary.

According to a particularly preferred development of the principal concept of the invention set out above, the starting duty cycle can be raised linearly to an intermediate duty cycle. The intermediate duty cycle value is in this case between the starting duty cycle value and the final duty cycle value and is in this respect lower than the final duty cycle value. The starting duty cycle is raised linearly to the intermediate duty cycle within a first period of time which can only end after or just before the point in time when the piston being displaced reaches the open position. This raising can be carried out as the piston is still being displaced or after it has reached its open position. Self-evidently, the point in time at which the piston reaches its open position can also lie within the time period for the starting duty cycle value being raised to the intermediate duty cycle value, and therefore the raising begins before the piston reaches its end position and ends after the piston has reached the open position.

Based on this, the intermediate duty cycle can then be raised linearly to the final duty cycle before or after the piston has reached the open position. The raise occurs within a second time period following the first time period. The second time period can be shorter than the first time period. Raising the intermediate duty cycle to the final duty cycle ensures that the piston is also displaced into its open position despite any possible blockages, even if the intermediate duty cycle could not bring about a sufficiently high power of the drive means in order to provide the breakaway force required to overcome the blockage.

After the piston has reached its open position, the final duty cycle can be abruptly lowered to a holding duty cycle either directly or after a specified time period. Since it can be assumed that the piston is in its open position at the latest after the raise to the final duty cycle, the power of the drive means that is too high per se at this point in time can be correspondingly lowered by the final duty cycle being lowered. The holding duty cycle intended to be achieved by the lowering should be selected such that the piston in any case still remains in its open position. The piston is usually displaced into its open position counter to a restoring force which can result, for example, at least in part from a mechanical spring means. The restoring force is used in a targeted manner, for example, to displace the piston back into its closed position as required. Against this background, the holding duty cycle is selected such that the piston also remains in its previously assumed open position even when loaded with a restoring force. In other words, a type of equilibrium is ideally set between the counteracting influences from a drive force of the drive means acting on the piston and the restoring force loading the piston in the opposite direction, which leads to the piston remaining in its open position. Self-evidently, the drive force of the drive means can be somewhat greater than the restoring force, for example by 2% to 10%, so that in any case—even in the event of temporary effects and/or occurrences that influence the position of the piston—the position of the piston in its open position is ensured.

The vehicle seat valve is used to switch a fluid flow, preferably compressed air. This means that the fluid can flow when the vehicle seat valve is open (open position of the piston), whereas it is prevented from flowing when said valve is in a closed state (closed position of the piston). In this respect, as a switching unit, the vehicle seat valve has only two states. According to the invention, a fluid pressure of the fluid flow which can be switched by the vehicle seat valve can be detected. In particular if the fluid flow is detected downstream of the piston, conclusions can be drawn about the state of the piston in relation to its closed and/or open position. A detected increase in the fluid pressure can indicate, for example, that the piston is on the way into its open position or has already reached said position. Within the context of the method according to the invention, a blockage that is impeding the displacement of the piston toward its open position can be identified, for example, on the basis of the absence of an expected change in the fluid pressure during the manipulation of the drive means.

With regard to the displacement of the piston from its open position back into its closed position, the invention proposes further measures in order to be able to carry out this return displacement as quietly as possible:

The piston can preferably be initially displaced from its closed position toward its open position counter to a restoring force. The restoring force can result at least in part from a mechanical spring means. In order to now displace the piston from its open position back toward its closed position, the holding duty cycle can be lowered, at the beginning of the return displacement, until a drive force of the drive means acting on the piston is smaller than the restoring force loading the piston in the opposite direction. By lowering the holding duty cycle and consequently lowering the drive force of the drive means, the restoring force loading the piston is sufficient, starting from a particular value, for displacing the piston from its open position back toward its closed position. Since in this case the piston is not accelerated at the full power of the drive means, the abutment of the piston against a region of its movement boundary, which abutment happens when the closed position is reached, involves correspondingly little energy, and therefore noise emissions are reduced considerably.

It is conceivable for a fluid pressure acting on the piston when the piston is removed from its open position to increase the restoring force loading it. Therefore, within the context of the invention, the fluid pressure increasing the restoring force can be detected during the displacement of the piston back toward its closed position, the holding duty cycle then being lowered until a drive force of the drive means that acts on the piston is smaller than the restoring force that loads the piston in the opposite direction and is increased by the fluid pressure. In other words, this measure which further refines the method according to the invention also takes into account any possible influences of the fluid pressure on the piston, in order to lower the holding duty cycle to an ideal value that is as realistic as possible in terms of a quiet displacement of the piston back into its closed position.

The holding duty cycle can preferably be lowered linearly back to the rest duty cycle. This means that the holding duty cycle is lowered constantly over a period of time which is for example predefined. In this case, the lowering is carried out in such a way that the rest duty cycle is achieved as soon as the piston is in its closed position. Alternatively, the lowering can be carried out such that the rest duty cycle is only achieved after the piston is in its closed position. This ensures that the piston is never displaced back into its closed position at the full extent of the restoring force, which could otherwise cause corresponding noise when the structural movement boundary of said piston is reached.

The method according to the invention offers an extremely simple way of influencing the displacement movements of the piston of a vehicle seat valve in such a manner that otherwise perceptible noises can be largely reduced or even completely eliminated. By adapting the duty cycle of the pulse width modulation of the impulse voltage, forces which act on the piston and displace said piston can be kept within a constantly adapted framework which guarantees the displacement of the piston but never displaces the piston at too high a drive force where possible. In addition to the possible reduction in noise, this also results in the piston and/or its structural movement boundary being subjected to significantly less wear.

Furthermore, the invention is directed to a controller for at least one vehicle seat valve, for carrying out the method according to the invention.

The invention is also directed to a vehicle seat comprising at least one vehicle seat valve and a controller according to the invention.

The advantages of the controller according to the invention and/or the vehicle seat according to the invention have already been explained in detail in connection with the method according to the invention, and therefore, in order to avoid repetition, reference is made here to the relevant comments in this regard.

### BRIEF DESCRIPTION OF THE DRAWINGS

In the following, the present invention will be explained in greater detail with reference to an embodiment shown schematically. In the drawings:

FIG. 1 shows a schematic sequence of the method according to the invention for displacing the piston of a vehicle seat valve into its open position; and

FIG. 2 shows a schematic sequence of the method according to the invention for displacing the piston of a vehicle seat valve into its closed position.

### DETAILED DESCRIPTOIN OF PREFERRED EMBODIMENTS

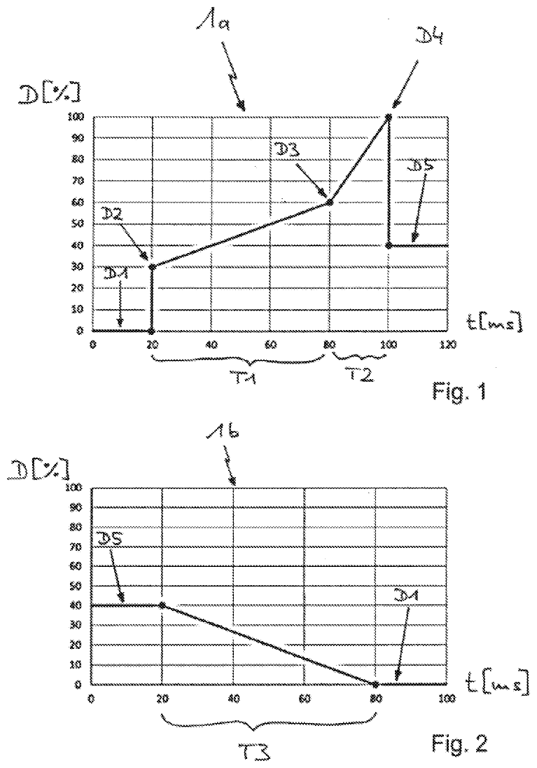

FIG. 1 shows a purely schematic sequence of the method according to the invention for displacing a piston of a vehicle seat valve (not shown in greater detail). In this case, the control of the vehicle seat valve is shown merely by means of a first function graph 1a, from which control an effective voltage applied to a drive means manipulating the piston is produced. The drive means is preferably an electromagnetic drive means.

The method according to the invention is based on an impulse voltage having a constant frequency, by means of the pulse width modulation (PWM) of which a correspondingly variable effective voltage can be applied to the drive means. By changing the effective voltage, the power of the drive means that actively displaces the piston into its closed position can be correspondingly regulated. For this purpose, a duty cycle D of the pulse width modulation is changed in the following manner:

At the beginning of the displacement of the piston, said piston is in its closed position. In the closed position, the piston is loaded and thus held by a spring means which is for example mechanical. In the closed position, the rest duty cycle D1 is 0%, so that an effective voltage applied to the drive means of 0.0 volts (V) is produced. Purely by way of example, in order to then displace the piston from its closed position toward its open position, the rest duty cycle D1 is abruptly increased to a starting duty cycle D2 after a time t of 20 milliseconds (ms). Purely by way of example, the starting duty cycle D2 is now 30%, and therefore almost 30% of the impulse voltage is now applied to the drive means as the effective voltage.

The starting duty cycle D2 is in principle selected such that, in normal operation, the piston moves from its closed position toward its open position counter to the restoring force loading it. The starting duty cycle D1 can already be sufficient for displacing the piston as far as into its open position, which it only reaches at a slow speed and force as a result of the reduced power of the drive means. As a result, in particular the abutment against the structural movement boundary of said piston is correspondingly gentle, so that resulting noise emissions are reduced to a minimum.

In order to overcome any possible movement blockages of the piston, the starting duty cycle D2 is raised to an intermediate duty cycle D3 over a first time period T1 of—in this case purely by way of example—60 ms. Purely by way of example, the intermediate duty cycle D3 is now 60%, and therefore almost 60% of the impulse voltage is now applied to the drive means as the effective voltage. The linear raise to the intermediate duty cycle D3 is advantageous in that, in the event of a possible movement blockage of the piston, the simultaneously increasing drive force of the drive means eventually reaches a level which could be sufficient for overcoming the movement blockage and thus displaces the piston into its open position. At the same time, only part of the maximum possible impulse voltage is applied to the drive means as the effective voltage, and therefore noise emissions which are possibly higher but still very low can result in this case, too.

If there is no movement blockage present, the piston, which is already in its open position as a result of the starting duty cycle D2, is merely pushed further against its structural movement boundary by this measure, as a result of which no noise develops. In this respect, raising the starting duty cycle D2 to the intermediate duty cycle D3 is understood to be a protective measure for ensuring that the piston does not remain in its closed position due to a movement blockage.

In order to overcome an even larger movement blockage of the piston that is still in its closed position or has become stuck on the way toward its open position, the intermediate duty cycle D3 is now raised to a final duty cycle D4 over a second time period T2 of—in this case purely by way of example—20 ms. As can be seen, the second time period T2 is significantly shorter than the first time period T1, and therefore, in combination with raising the duty cycle D by a further 40%, this produces a significantly steeper curve of the function graph 1a during the second time period T2.

Purely by way of example, the final duty cycle D4 is now 100%, and therefore almost 100% of the impulse voltage is now applied to the drive means as the effective voltage. The linear raise to the final duty cycle D4 is advantageous in that, in the event of a possible movement blockage of the piston, the simultaneously increasing drive force of the drive means eventually reaches a level which could be sufficient for overcoming the movement blockage and thus finally displaces the piston into its open position. A movement blockage that is potentially present in the region of the open position of the piston can also be overcome hereby, in order to finally displace said piston into its open position. In such a scenario outside of normal operation, the speed and force of the piston, produced as a result of the now significantly higher drive power of the drive means, can be accompanied by correspondingly greater noise emissions, but nevertheless it is ensured that the piston is in any case displaced into its open position.

With the measures taken previously, it can be assumed that the piston is now definitively in its open position. In a next step, the final duty cycle D4 is now abruptly lowered to a holding duty cycle D5. Purely by way of example, this is now 40%, and therefore 40% of the impulse voltage is now applied also to the drive means as the effective voltage.

The holding duty cycle D5 is selected such that the piston is in any case securely held in its open position and the vehicle seat valve fulfills the function assigned thereto.

In principle, a fluid pressure of a fluid flow which can be switched by the vehicle seat valve, which fluid pressure acts on the piston, can be detected. If the duty cycle D is manipulated in order to induce the displacement of the piston from its closed position, but no expected change in the fluid pressure is identified, the first time period T1 can be shortened, for example, and/or the intermediate duty cycle D3 can be greater than the value set out here, for example, in order for the clearly present movement blockage of the piston to be overcome as quickly as possible.

FIG. 2 also shows, in a purely schematic manner by means of a second function graph 1b, the sequence of the method according to the invention for displacing the piston back into its closed position. As can be seen, the holding duty cycle D5 is initially 40%, for example, in the open position of the piston. Proceeding from this, after 20 ms, the holding duty cycle D5 is lowered, purely by way of example, to the initial rest duty cycle D1 of 0% over a third time period T3. Purely by way of example, the third time period T3 is in this case 60 ms.

As a result of loading the piston with the restoring force, at some point during the lowering of the holding duty cycle D5 a point in time is reached at which the restoring force is greater than the current duty cycle D, so that the piston is displaced gently back into its closed position by the restoring force. The third time period T3 is selected such that, under normal circumstances, the rest duty cycle D1 is only achieved as soon as or after the piston has arrived in its closed position. In so doing, the speed and force of the moving piston are also reduced to a minimum, thereby achieving a significant reduction in noise.

A fluid pressure that increases the restoring force loading the piston can self-evidently also be detected during the displacement of the piston back toward its closed position and be taken into account when lowering the holding duty cycle D5. This consideration can be expressed, for example, in a corresponding adjustment of the third time period T3.

### LIST OF REFERENCE SIGNS:

1a first function graph
1b second function graph
D duty cycle of the pulse width modulation in percent [%]
D1 rest duty cycle
D2 starting duty cycle
D3 intermediate duty cycle
D4 final duty cycle
D5 holding duty cycle
t time in milliseconds [ms]
T1 first time period between D2 and D3
T2 second time period between D3 and D5
T3 third time period between D5 and D1

What is claimed is:

1. A method for controlling a vehicle seat valve, the piston of which is actively displaced from a closed position into an open position or vice versa by an electrical voltage being applied to an in particular electromagnetic drive means, wherein the power of the drive means is regulated via an effective voltage which can be changed by means of pulse width modulation of an impulse voltage that has a constant frequency, a duty cycle (D) of the pulse width modulation firstly being increased from a rest duty cycle (D1), in particular 0%, to a starting duty cycle (D) of less than 100%, in particular of less than 50%, in order to displace the piston from its closed position toward its open position, and the duty cycle only being raised to a final duty cycle (D4), in particular to 100%, when the piston has reached the open position and/or if a blockage impeding the displacement of the piston before it reaches its open position is identified.

2. The method according to claim 1, wherein the starting duty cycle (D2), in particular before or after the piston has reached the open position, is firstly raised linearly within a first time period (T1) to an intermediate duty cycle (D3) that is smaller than the final duty cycle (D4).

3. The method according to claim 2, wherein the intermediate duty cycle (D3), before or after the piston has reached the open position, is raised linearly to the final duty cycle (D4) within a second time period (T2) that is in particular shorter than the first time period (T1).

4. The method according to claim 1, wherein the final duty cycle (D4) being lowered, in particular abruptly, to a holding duty cycle (D5) after the piston has reached the open position, such that the piston loaded with a restoring force in particular resulting from a mechanical spring means is held in its open position by a drive force of the drive means that counteracts said restoring force.

5. The method according to claim 1, wherein a fluid pressure of a fluid flow which can be switched by the vehicle seat valve is detected, a blockage impeding the displacement of the piston toward its open position being identified on the basis of the absence of an expected change in the fluid pressure during the manipulation of the drive means.

6. The method according to claim 4, wherein the piston is displaced from its closed position toward its open position counter to a restoring force that in particular results from a mechanical spring means, the holding duty cycle (D5) being lowered, at the beginning of the displacement of the piston from its open position back toward its closed position, until a drive force of the drive means that acts on the piston is smaller than the restoring force that loads the piston in the opposite direction.

7. The method according to claim 4, wherein a fluid pressure that increases the restoring force loading the piston is detected during the displacement of the piston back toward its closed position, the holding duty cycle (D5) being lowered until a drive force of the drive means that acts on the piston is smaller than the restoring force that loads the piston in the opposite direction and is increased by the fluid pressure.

8. The method according to claim 4, wherein the holding duty cycle (D5) being lowered linearly to the rest duty cycle (D1) in particular during the displacement of the piston back toward its closed position or after the piston has reached the closed position, such that the rest duty cycle (D1) is only reached as soon as or after the piston is in its closed position.

9. A controller for at least one vehicle seat valve, for carrying out the method according to claim 1.

10. A vehicle seat comprising at least one vehicle seat valve and a controller according to claim 9.
